(19) United States
(12) Patent Application Publication
(10) Pub. No.: US 2001/0011495 A1
(43) Pub. Date: Aug. 9, 2001

(54) MUSIC BOX WITH INTEGRATED LIGHT SENSOR

(76) Inventor: JIN SONG, DALLAS, TX (US)

Correspondence Address: CARSTENS YEE & CAHOON LLP, P O BOX 802334, DALLAS, TX, 75380

(21) Appl. No.: 09/338,879

(22) Filed: Jun. 23, 1999

Related U.S. Application Data
(63) Continuation of application No. 09/263,648, filed on Mar. 5, 1999, now abandoned.

(51) Int. Cl. G10H 1/00

(52) U.S. Cl. 84/600

(57) ABSTRACT

A music box plays music or another pleasant sound only when the lid is opened. The music is stored in a memory device. This can allow for a selection of various songs or sounds, as well as selections of longer duration than typically found in standard mechanical music boxes. Likewise, the output from this memory device is triggered by a light sensitive sensor. The sensor can be located on either the box or its lid, but it is located so that it is obscured from light when the lid is closed.

### CROSS-REFERENCE TO CO-PENDING APPLICATIONS

The present application is a continuation in part of co-pending patent application Serial No. 09/263648 filed on Mar. 5, 1999, and entitled “Music Box With Integrated Light Sensor.”

### BACKGROUND OF THE INVENTION

1. Technical Field

The present invention relates to an improved music box and more specifically to a music box that uses a light sensor within the box to initiate the playing of music or any sound once the box lid is opened. Additionally, the music box can have a second memory for storing recorded voice messages.

2. Description of Related Art

Music boxes have been used for years to store jewelry or pictures and to play music when the box is opened. The music is stored on a cylinder that is powered by a wound spring. When the box is opened, a mechanical trigger allows the cylinder to turn. Cams in the cylinder strike tuned prongs. Placement of the cams determine the tune played.

It is impossible to store the sound of the ocean on such a simple device. Likewise, only the simplest tunes can be stored. A need exists for a better method of diameter of the storage cylinder. A need exists for an improved music box that can store longer tunes. Further, music boxes are limited to a single song. A need exists for a method of storing several tunes from which the user can choose. A need also exists for a a music box that allows the user to store a personalized message for a loved one.

### SUMMARY OF THE INVENTION

The present invention relates to an improved music box that addresses the deficiencies of existing music boxes. The present music box is a box with a hinged lid. Music or other sounds can be stored on a solid state memory device. More than one memory can be provided in each box. Thus, multiple songs can be stored. A switch can allow the user to select between the songs or sounds. Indeed, the memory components could be recordable to allow the user to record his own musical selection, voice or other sound.

The music box can be actuated with a light sensor placed on the box or lid so that when the lid is opened, light strikes the sensor and activates the memory devices. The light sensor provides the advantage of being highly reliable and easily integrated into the electrical circuit containing the memory devices.

It should be appreciated that the features described can all be incorporated into an embodiment, or only select features incorporated. In other words, a mechanical cylinder could be used for storage and activation could be triggered with a light sensor. Likewise, a solid state memory could be activated by a mechanical trigger. Further, a single memory can be used or several memories, or a single memory with multiple elements recorded therein.

### BRIEF DESCRIPTION OF THE DRAWINGS

The novel features believed characteristic of the present invention are set forth in the appended claims. The invention itself, however, as well as a preferred mode of use, further objects and advantages thereof will be best understood by reference to the following detailed description of an illustrative embodiment when read in conjunction with the accompanying drawings, wherein:

FIG. 1 is a perspective view of the music box embodying the present invention;

FIG. 2 is a schematic of the circuitry of the music box having a single voice synthesizer module; and, FIG. 3 presents an alternative embodiment of the invention, which depicts a schematic of the mechanical music producing means incorporated into the music box.

### DETAILED DESCRIPTION OF THE DRAWINGS

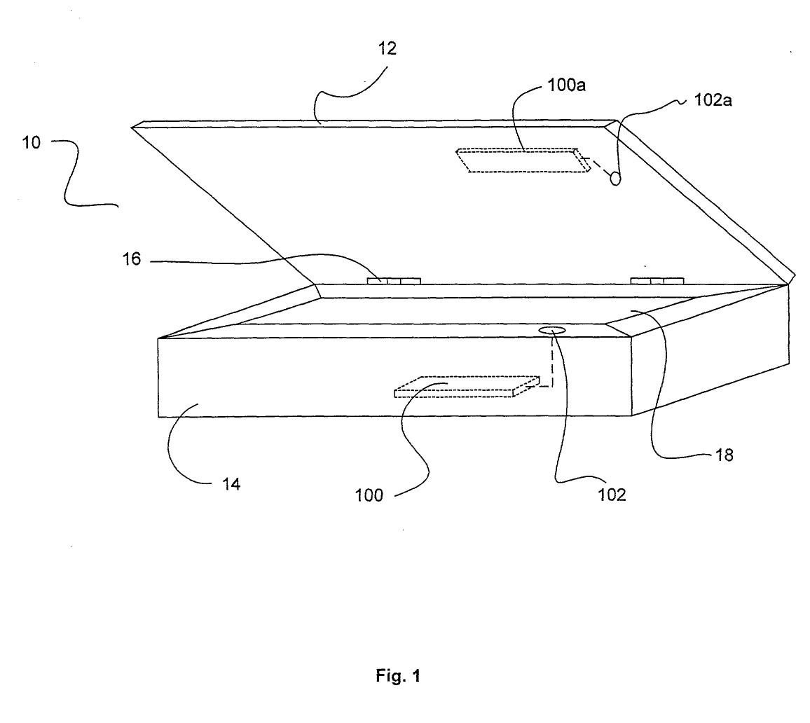

A light triggered music box embodying the present invention is shown in FIGS. 1, 2 and 3. The music box contains a sound producing device and a light sensitive sensor to activate the sound producing device, with said sensor being responsive to the presence or absence of light.

FIG. 1 provides a perspective view of the music box 10. The box has a base 14 and a cover or lid 12. The base 14 can be any suitable shape but is shown as a square or rectangular. The cover 12 is attached to base 14 by two hinges 16. The exterior of the music box 10 can be physically decorated and/or ornamented in a variety of ways. Base 14 defines an enclosure 18 that can contain a sound producing device 100 with an attached light sensitive sensor 102. In an alternative embodiment, a mechanical switch could be used. The device 100 is an electrical circuit and can contain a memory device for storage of at least one musical tune or other sound. The circuit 100 can be located in any suitable location. For example, the circuit 100 can be in the base 14. Alternatively, the circuit 100a can be on the lid 12. The sensor 102 can be placed in a position so that it is exposed to light when the lid 12 is in an open position. Likewise, the sensor 102 is obscured from light when the lid 12 is in a closed position. Thus, the sensor 102 can be mounted on the base 14 or sensor 102a can be located on the lid 12.

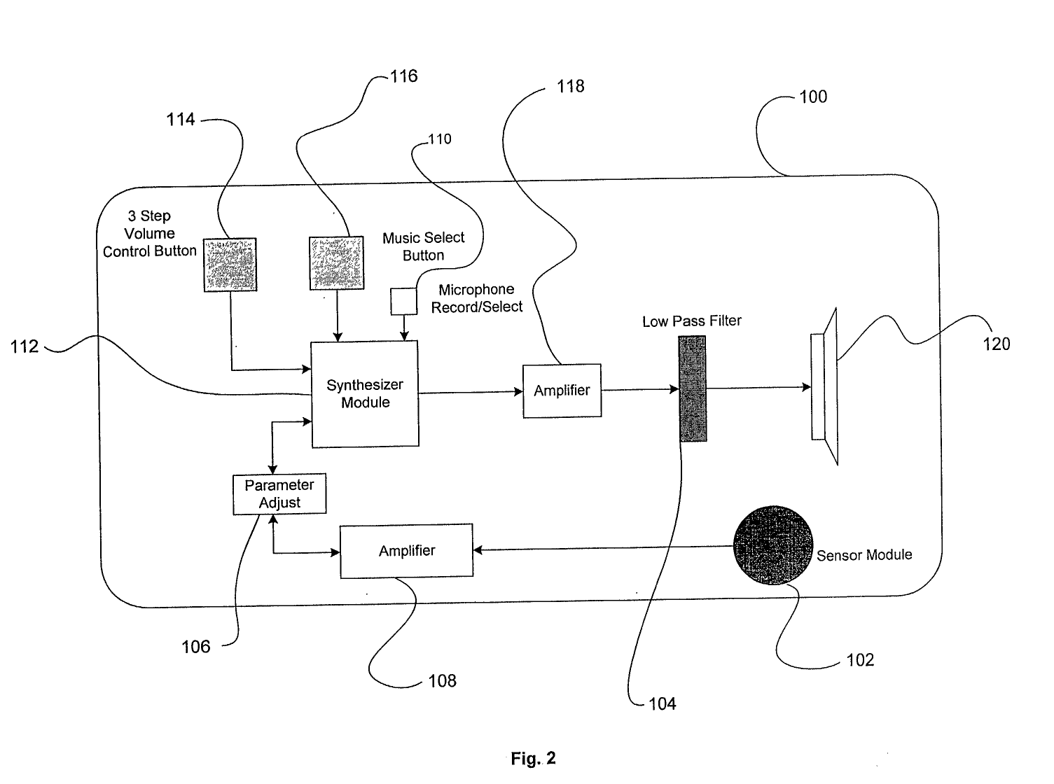

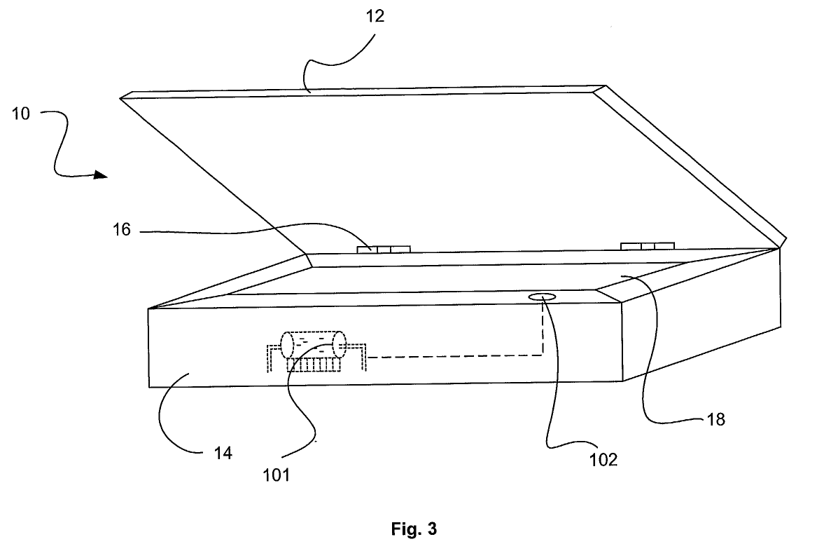

FIG. 2 is the schematic of the sound producing device 100. Sound producing device 100 is an electronic module containing programmed or programmable components that produce a desired sequence of sounds. In one embodiment, the light sensitive sensor module emits an output signal when exposed to ambient light. A switch can be located in the sensor 102, the module 112 or elsewhere. A minimum light intensity will close this switch.

Amplifier 108 amplifies this output and sends it to a Voice Synthesizer Module 112. The output of the module 112 can be amplified by amplifier 118. Likewise, a low pass filter 104 can be used to condition the output signal before reaching the speaker 120. The parameter adjust 106 can be used to select the initial volume settings or song choices. FIG. 3 illustrates a music box using a conventional cylinder 101 for storage along with a light sensor 102 for actuation.

The sound producing means 100 can be powered by batteries or other suitable power sources. The sound produced can be music, such as a popular song or a pleasant sound as the ocean. A music select button 116 allows the user to select one of several programmed works of music or sound and volume control button 114 controls the volume of the programmed music being produced. A timing device can be used to stop the music output after a predetermined period. This device can be located in the module 112.

A record feature can also be included, wherein the user could record a message, song, or other sound into memory. For instance, if the music box were given as a gift, then the giver could record a message to the recipient. Perhaps a husband could record a message to his wife which she would receive when she opened the music box. The recorded message could be played singly or in combination with another recorded song in the background. Thus, the outputs of the two memories could be fed to a single speaker or to two speakers. The recorded message could be permanently recorded or temportarily recorded. In this embodiment, the box could have a volume control, a record button, a record indicator light activated when the device was in a record mode, and a microphone for converting the sound into an electrical signal. The present invention can be either battery powered or could be plugged into a standard wall outlet for 110 volt AC power.

The description of the present invention has been presented for purposes of illustration and description, but is not limited to be exhaustive or limited to the invention in the form disclosed. Many alternative modifications and variations will be apparent to those of ordinary skill in the art. The embodiment was chosen and described in order to best explain the principles of the invention, the practical application to enable others of ordinary skill in the art to understand the invention for various embodiments with various modifications as suited to the particular use contemplated. In view of these and other variations, which will now be apparent in view of this disclosure, reference should be made to the appended claims rather than the foregoing specification in assessing the scope of the invention in which exclusive rights are claimed.

What is claimed is:

1. A music box comprising:
(a) a box with a lid;
(b) a first memory for storing a sound coupled to said box;

2. The music box of claim 1 further comprises:
(c) a light sensitive sensor coupled to said memory for triggering the playing of its stored sound.

3. The music box of claim 1 further comprising a timing means coupled to said sound producing device.

4. The music box of claim 2 wherein said sensor is placed on said box.

5. The music box of claim 2 wherein said sensor is placed on said lid.

6. The music box of claim 1 wherein said memory contains at least one song or sound.

7. The music box of claim 1 further comprises:
(c) a second memory coupled to record means for recording a voice or other sound into said second memory.

8. The music box of claim 7 wherein said second memory is a permanent memory.

9. The music box of claim 7 wherein said second memory is a temporary memory.

10. A method of actuating a sound storage device located in a music box having a lid, comprising the steps of:
(a) placing a light sensitive sensor on said music box wherein said sensor is obscured from an ambient light when the lid is in a closed position;
(b) triggering a memory output when said sensor is exposed to ambient light.

11. The method of claim 10 further comprises:
(c) selecting a stored output in the memory;

12. The method of claim 11 further comprises selecting a stored song from a selection of at least one songs.

13. The method of claim 10 further comprises:
(c) selecting a volume for the output.

14. The method of claim 10 further comprises conditioning said output.
